(19) United States
(12) Patent Application Publication
(10) Pub. No.: US 2020/0097641 A1
(43) Pub. Date: Mar. 26, 2020

(54) INFORMATION PROCESSING APPARATUS, INFORMATION PROCESSING SYSTEM, AND INFORMATION PROCESSING METHOD

(71) Applicant: eNFC Inc., Minato-ku Tokyo (JP)

(72) Inventor: Takanori WASHIRO, Minato-ku, Tokyo (JP)

(73) Assignee: eNFC Inc., Minato-ku Tokyo (JP)

(21) Appl. No.: 16/619,310

(22) PCT Filed: Jun. 8, 2018
(86) PCT No.: PCT/JP2018/022101

§ 371 Date: Dec. 4, 2019

(30) Foreign Application Priority Data
Jun. 8, 2017 (JP) 2017-113128

(51) Int. Cl. G06F 21/31; G06F 3/02; G06F 3/041; G06K 9/00; H04B 13/00; G06Q 20/34

(52) U.S. Cl. CPC G06F 21/31; G06F 3/02; G06F 3/041; G06Q 20/341; G06K 9/00087; H04B 13/00; G06K 9/00013

(57) ABSTRACT

A more useful information processing apparatus, information processing system, and information processing method are provided. An information processing apparatus includes an operation interface and a controller. The operation interface receives an operation by a user and is capable of electric field communication with an electric field communication terminal. The controller executes a predetermined process, using information acquired by electric field communication, when detecting execution of a predetermined operation on the operation interface.

### CROSS-REFERENCE TO RELATED APPLICATION

The present application claims priority to and the benefit of Japanese Patent Application No. 2017-113128 filed Jun. 8, 2017, the entire contents of which are incorporated herein by reference.

### TECHNICAL FIELD

The present disclosure relates to an information processing apparatus, an information processing system, and an information processing method capable of executing a predetermined process based on information acquired by electric field communication using electric field signals and based on other input.

### BACKGROUND

Apparatuses for payment using a non-contact integrated circuit (IC) card are known. For example, patent literature (PTL) 1 discloses a system for selecting a product to purchase using a terminal apparatus that includes a touch panel and then paying with an IC card.

A known way to increase security on an apparatus for authenticating identity is to combine a plurality of authentication methods. For example, PTL 2 discloses an authentication apparatus that uses both authentication by PIN number and biometric authentication.

### CITATION LIST

### Patent Literature

PTL 1: JP2015-215697A

PTL 2: JP2008-158627A

### SUMMARY

### Technical Problem

To make payment using the system disclosed in PTL 1, a user needs to operate the touch panel and then swipe the IC card in a reader/writer. It would be less burdensome and more useful for the user if the number of user operations could be reduced.

To perform authentication using the authentication apparatus disclosed in PTL 2, the user needs to perform a plurality of operations for authentication. The combination of a plurality of authentication methods for increased security further increases the number of operations the user performs for authentication. The user is more likely to be irritated, however, as the number of operations increases. It would be more useful for the user if security could be increased without increasing the number of user operations.

The present disclosure has been conceived in light of these circumstances and aims to provide an information processing apparatus, an information processing system, and an information processing method capable of increasing usefulness.

### Solution to Problem

To resolve the aforementioned problem, an information processing apparatus according to a first aspect includes:

an operation interface configured to receive an operation by a user and to be capable of electric field communication with an electric field communication terminal; and

a controller configured to execute a predetermined process, using information acquired by electric field communication, when detecting execution of a predetermined operation on the operation interface.

In an information processing apparatus according to a second aspect, the controller is configured to execute the predetermined process when judging that the acquired information satisfies a condition related to acquisition information.

In an information processing apparatus according to a third aspect, the operation interface is configured by a keyboard; and

the predetermined operation is an operation on a predetermined key of the keyboard.

In an information processing apparatus according to a fourth aspect, the operation interface is configured by a touch panel; and

the predetermined operation is an operation on a predetermined area of the touch panel.

In an information processing apparatus according to a fifth aspect, the predetermined process is electronic payment.

In an information processing apparatus according to a sixth aspect, the predetermined process is an authentication process.

In an information processing apparatus according to a seventh aspect, the predetermined process is a process to display information having content corresponding to the acquired information on a display.

In an information processing apparatus according to an eighth aspect, the controller is configured to store the acquired information in a storage in association with an operation executed on the operation interface.

An information processing apparatus according to a ninth aspect includes:

a biological information acquisition interface capable of acquiring biological information of the user and capable of electric field communication with an electric field communication terminal; and

a controller configured to execute a predetermined process when judging that biological information acquired by the biological information acquisition interface satisfies a condition related to a living body and judging that information acquired by electric field communication satisfies a condition related to acquisition information.

In an information processing apparatus according to a tenth aspect, the biological information acquisition interface is configured by a fingerprint sensor capable of acquiring information related to a fingerprint of the user.

In an information processing apparatus according to an eleventh aspect, the controller is configured to acquire information used to judge whether the condition related to the living body is satisfied from the electric field communication terminal by electric field communication.

An information processing system according to a twelfth aspect includes:

an electric field communication terminal configured to transmit information by electric field communication while being worn by a user; and

an information processing apparatus configured to acquire the information from the electric field communication terminal by electric field communication and configured to execute a predetermined process, using the acquired information, when detecting execution of a predetermined process on an operation interface.

An information processing system according to a thirteenth aspect includes:

an electric field communication terminal configured to transmit information by electric field communication while being worn by a user; and

an information processing apparatus configured to acquire the information from the electric field communication terminal by electric field communication using a biological information acquisition interface capable of acquiring biological information of the user and configured to execute a predetermined process when judging that biological information acquired by the biological information acquisition interface satisfies a condition related to a living body and judging that the acquired information satisfies a condition related to acquisition information.

An information processing method according to a fourteenth aspect is for execution by an information processing apparatus and includes:

detecting an operation executed on an operation interface;

acquiring information from an electric field communication terminal by electric field communication; and

executing a predetermined process, using the acquired information, when execution of a predetermined operation on the operation interface is detected.

An information processing method according to a fifteenth aspect is for execution by an information processing apparatus and includes:

acquiring, using a biological information acquisition interface, biological information of a user;

acquiring, using the biological information acquisition interface, information from an electric field communication terminal by electric field communication; and

executing a predetermined process when it is judged that the acquired biological information satisfies a condition related to a living body and that the acquired information satisfies a condition related to acquisition information.

### Advantageous Effect

The information processing apparatus, information processing system, and information processing method according to the present disclosure are capable of increasing usefulness.

Other aims, features, and advantages of the present disclosure will become clear in the detailed description below, which is based on embodiments of the present disclosure and the appended drawings.

### BRIEF DESCRIPTION OF THE DRAWINGS

In the accompanying drawings:

FIG. 1 is a schematic diagram of an information processing system according to a first embodiment of the present disclosure;

FIG. 2 is a functional block diagram illustrating an example schematic configuration of the information processing apparatus of FIG. 1;

FIG. 3 is a schematic view illustrating operations of the information processing apparatus of FIG. 1 as an electric field communication apparatus;

FIG. 4 schematically illustrates the function of a terminal device in FIG. 3;

FIG. 5 is a functional block diagram illustrating an example of the schematic configuration of the body of the electric field communication terminal of FIG. 1;

FIG. 6 schematically illustrates the state in which an electric field communication terminal is coupled to a dielectric;

FIG. 7 schematically illustrates an example of a coupled state allowing electric field communication to be established between an information processing apparatus and an electric field communication terminal;

FIG. 8 schematically illustrates an example of a coupled state in which electric field communication is not established between an information processing apparatus and an electric field communication terminal;

FIG. 9 schematically illustrates an example of an information processing system configured by coupling an electric field communication terminal to a human body;

FIG. 10 is a flowchart illustrating an example of information processing by a controller of the information processing apparatus of FIG. 2;

FIG. 11 is a schematic diagram of an information processing system according to a second embodiment of the present disclosure;

FIG. 12 is a functional block diagram illustrating an example schematic configuration of the information processing apparatus of FIG. 11;

FIG. 13 is a flowchart illustrating an example of information processing by a controller of the information processing apparatus of FIG. 12;

FIG. 14 is a schematic diagram of an information processing system according to a third embodiment of the present disclosure;

FIG. 15 is a functional block diagram illustrating an example schematic configuration of the information processing apparatus of FIG. 14;

FIG. 16 is a flowchart illustrating an example of information processing by a controller of the information processing apparatus of FIG. 15;

FIG. 17 is a schematic diagram of an information processing system according to a fourth embodiment of the present disclosure;

FIG. 18 is a functional block diagram illustrating an example schematic configuration of the information processing apparatus of FIG. 17;

FIG. 19 is a flowchart illustrating an example of information processing by a controller of the information processing apparatus of FIG. 18; and

FIG. 20 is a functional block diagram illustrating the schematic configuration of a modification to an electric field communication terminal.

### DETAILED DESCRIPTION

Embodiments of the present disclosure are described below in detail with reference to the drawings.

### First Embodiment

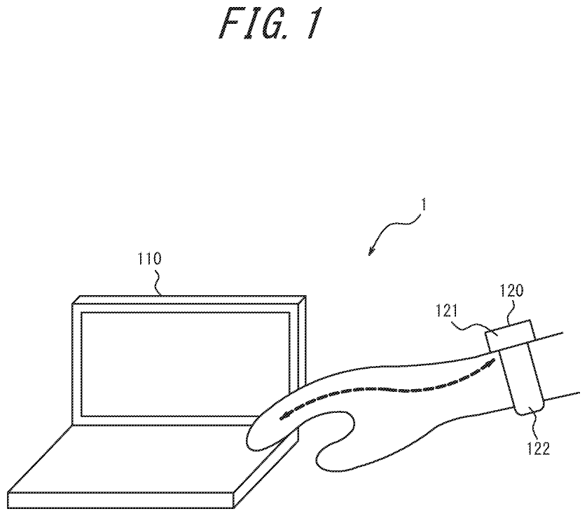

FIG. 1 is a schematic diagram of an information processing system 1 according to a first embodiment of the present disclosure. The information processing system 1 includes an information processing apparatus 110 and an electric field communication terminal 120.

The information processing apparatus 110 in the present embodiment is described below as being implemented by a personal computer. The information processing apparatus 110 is not, however, limited to being a personal computer and may be implemented by any apparatus, such as a terminal, that has the functions described in the present embodiment. The information processing apparatus 110 is capable of electric field communication using electric field signals.

The electric field communication terminal 120 is used while worn by a user. The electric field communication terminal 120 is, for example, worn on the wrist, arm, or the like. The electric field communication terminal 120 is capable of electric field communication using electric field signals while being worn by the user.

The electric field communication terminal 120 includes a body 121 and a wearable portion 122. The body 121 includes functional components for the electric field communication terminal 120 to perform electric field communication. Details on the functional components of the body 121 are provided below. The wearable portion 122 is a mechanism for the user to maintain the electric field communication terminal 120 in a state of being worn. The wearable portion 122 is, for example, configured as a belt, wristband, or armband wearable by being wound around the user's wrist, arm, or the like. The wearable portion 122 is not, however, limited to being a belt and may be configured as any shape wearable by the user. The wearable portion 122 may, for example, be shaped as a ring that is wearable on the user's finger. In the present embodiment, the electric field communication terminal 120 is described as being worn on the user's wrist.

The information processing apparatus 110 and the electric field communication terminal 120 perform electric field communication using a human body (user), which is a dielectric, as a transmission medium. Accordingly, electric field communication occurs when the user wearing the electric field communication terminal 120 touches the information processing apparatus 110.

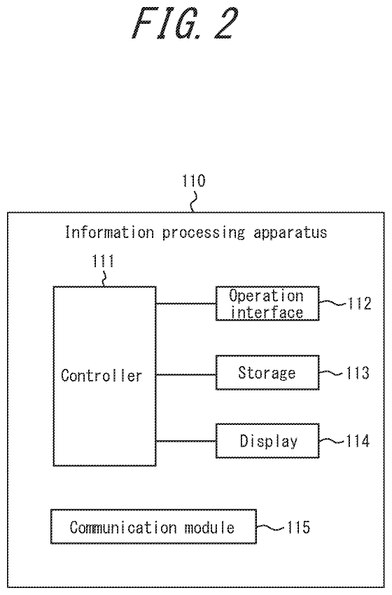

FIG. 2 is a functional block diagram schematically illustrating the configuration of the information processing apparatus 110 in FIG. 1. As illustrated in FIG. 2, the information processing apparatus 110 includes a controller 111, an operation interface 112, a storage 113, a display 114, and a communication module 115.

The controller 111 is a processor that controls and manages the information processing apparatus 110 overall, starting with the functional blocks of the information processing apparatus 110. The controller 111 is a processor, such as a central processing unit (CPU), that executes programs prescribing control procedures. Such programs are, for example, stored in the storage 113 or on an external storage medium.

When the controller 111 detects that a predetermined process has been performed on the operation interface 112, the controller 111 executes a predetermined process using information acquired from the electric field communication terminal 120 by electric field communication. Details of the processes executed by the controller 111 are provided below.

The operation interface 112 receives user operations. In the present embodiment, the operation interface 112 may, for example, be configured by a keyboard. The operation interface 112 is not, however, limited to a keyboard and may be configured by any member capable of receiving user operations. The operation interface 112 may, for example, be configured by a mouse, operation buttons, operation levers, or the like. When the user performs an operation on the operation interface 112, a signal indicating the content of the performed operation is inputted to the controller 111.

The storage 113 may be configured by a semiconductor memory, a magnetic memory, or the like. The storage 113 stores a variety of information, programs for causing the information processing apparatus 110 to operate, and the like. The storage 113 may also function as a working memory. For example, the storage 113 stores information related to conditions for the controller 111 to execute a predetermined process. The storage 113 may, for example, store a log of operations performed on the operation interface 112.

The display 114 displays various information. The display 114 may, for example, be configured by a well-known display such as a liquid crystal display (LCD), an organic electro-luminescence display (OELD), an inorganic electro-luminescence display (IELD), or the like.

The communication module 115 causes the information processing apparatus 110 to function as an electric field communication apparatus capable of electric field communication by electric field signals. In other words, an input/output terminal of the communication module 115 is connected to a substrate ground, or a metal portion of a housing or the like, in the information processing apparatus 110. The substrate ground or metal portion of the housing or the like functions as a coupling electrode. The information processing apparatus 110 thereby transmits and receives electric field signals, through a dielectric, to and from the electric field communication terminal 120 that is in contact or nearby.

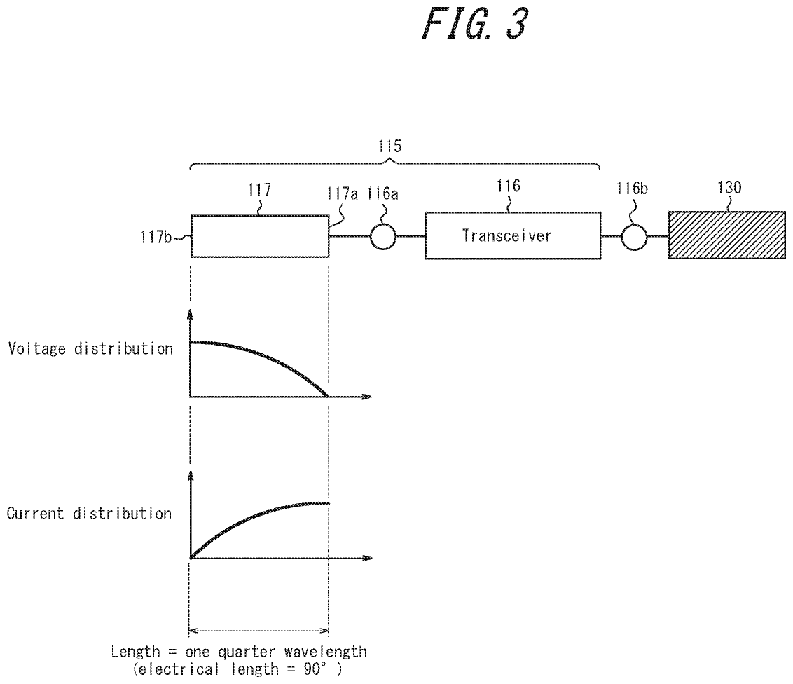

FIG. 3 is a schematic view illustrating operations of the information processing apparatus 110 as an electric field communication apparatus. The communication module 115 includes a first input/output terminal 116a, a transceiver 116, and a terminal line 117. The transceiver 116 and the terminal line 117 are connected electrically to the first input/output terminal 116a. During communication with the electric field communication terminal 120, the transceiver 116 transmits and receives high-frequency signals (or high-frequency power) between 10 kHz and 10 GHz, for example. The first input/output terminal 116a is connected to the terminal line 117 that functions as a virtual ground. Details on the terminal line 117 are provided below. The first input/output terminal 116a may be connected to ground instead of to the terminal line 117.

The transceiver 116 is connected to a second input/output terminal 116b. The second input/output terminal 116b functions as a coupling electrode that couples with a dielectric. At least a portion of the operation interface 112 in the information processing apparatus 110 functions as the second input/output terminal 116b. The entire information processing apparatus 110 (the body thereof) may function as the second input/output terminal 116b. In the present embodiment, the entire information processing apparatus 110 is described below as functioning as the second input/output terminal 116b. When the second input/output terminal 116b is coupled electrically to a transmission medium 130, which is constituted by a human body, electric field communication is established between the information processing apparatus 110 and the electric field communication terminal 120.

The terminal line 117 functioning as a virtual ground is now described. The first input/output terminal 116a is coupled electrically to the terminal line 117. The terminal line 117 is formed by a conductor, such as metal, or a dielectric. As an example, the transceiver 116 is described as transmitting high-frequency signals.

When the transceiver 116 transmits a high-frequency signal by electric field communication with the electric field communication terminal 120, current flows to the terminal line 117 from the first input/output terminal 116a of the transceiver 116 coupled to the terminal line 117. At the same time, current of the same magnitude as the current flowing to the terminal line 117 flows in the opposite direction from the second input/output terminal 116b to the transmission medium 130 constituted by a human body or the like. In this way, the transceiver 116 sends a high-frequency signal to the transmission medium 130.

The terminal line 117 has an electrical length of 90 degrees. An electrical length of 90 degrees means that the length of the line from an end 117a connected to the first input/output terminal 116a to the other end 117b is one quarter of the wavelength of the high-frequency signal to be transmitted. In other words, the phase of the high-frequency signal to be transmitted advances 90 degrees over the length from the end 117a connected to the first input/output terminal 116a to the other end 117b.

Consequently, the current that flows to the terminal line 117 side from the end 117a connected to the first input/output terminal 116a is subsequently reflected at the other end 117b of the terminal line 117 and returns to the end 117a connected to the first input/output terminal 116a, thereby traversing a distance of half a wavelength. The phase thus advances 180 degrees.

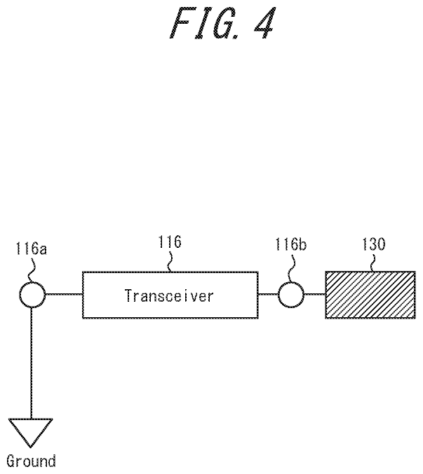

At this time, as illustrated in FIG. 3, the transceiver 116 inputs a high-frequency signal to the terminal line 117, which has an electrical length of 90 degrees, i.e. one quarter of the wavelength of the high-frequency signal to be transmitted, and the end 117b of which is open. Consequently, a standing wave is generated in the terminal line 117, with maximum voltage amplitude and zero current amplitude at the end 117b and zero voltage amplitude and maximum current amplitude at the end 117a, and current flows to the end 117a. In other words, when the terminal line 117 has an electrical length of 90 degrees, the voltage amplitude at the end 117a is zero, but current flows. Hence, as illustrated schematically in FIG. 4, the end 117a functions as though it were virtually short circuited to ground. The first input/output terminal 116a connected to the terminal line 117 can thus be considered a short-circuit terminal that is virtually connected to ground.

As illustrated in FIG. 3, the current that flows into the first input/output terminal 116a is maximized when the electrical length of the terminal line 117 is 90 degrees, i.e. when the signal input from the end 117a of the terminal line 117 connected to the first input/output terminal 116a of the transceiver 116 is reflected at the other end 117b and returns so that the phase of the reflected wave is 180 degrees. Consequently, electric field communication is most efficient when the electrical length of the terminal line 117 is 90 degrees. During electric field communication, however, a certain advantage in high-frequency transmission is still obtained by the electrical length of the terminal line 117 being within a range of ±45 degrees of 90 degrees, i.e. with the phase of the reflected wave being in a range greater than 90 degrees and less than 270 degrees. It thus suffices for the terminal line 117 to have an electrical length of substantially 90 degrees, which includes a range of ±45 degrees from 90 degrees. The terminal line 117 may have an electrical length of ((2n+1)×90±45) degrees, where n is an integer of at least 0. When the terminal line 117 has an electrical length of ((2n+1)×90±45) degrees, the terminal line 117 functions as a virtual ground by the same principle as described with reference to FIG. 3.

Next, the configuration of the electric field communication terminal 120 is described. As described above, the electric field communication terminal 120 includes the body 121 and the wearable portion 122.

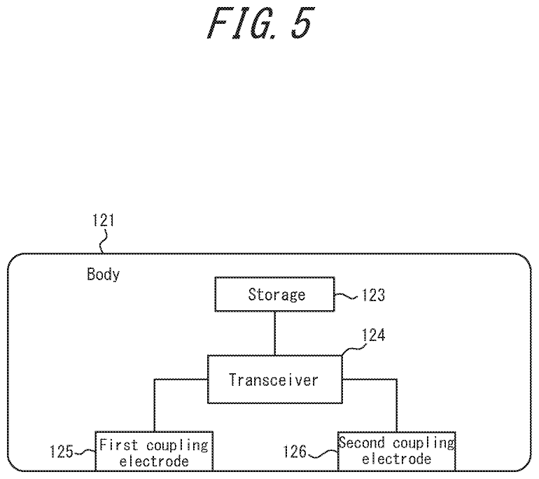

FIG. 5 is a functional block diagram schematically illustrating an example of the configuration of the body 121 of the electric field communication terminal 120. The body 121 includes a storage 123, a transceiver 124, a first coupling electrode 125, and a second coupling electrode 126.

The storage 123 stores various information. The storage 123 may, for example, be configured by an integrated circuit (IC) chip. For example, the storage 123 stores unique identification information (ID) in one-to-one association with the electric field communication terminal 120. The ID may, for example, be in one-to-one association with the user of the electric field communication terminal 120.

During electric field communication with the information processing apparatus 110, the transceiver 124 transmits and receives high-frequency signals (or high-frequency power) between 10 kHz and 10 GHz, for example. The functions of the transceiver 124 may be similar to those of the transceiver 116 described above. The transceiver 124 is coupled electrically with the first coupling electrode 125 and the second coupling electrode 126.

The first coupling electrode 125 and the second coupling electrode 126 are coupling electrodes that couple to a human body, which is a dielectric, when the user is wearing the electric field communication terminal 120 (wearing state). In other words, the first coupling electrode 125 and the second coupling electrode 126 are disposed at positions in the body 121 that are in contact with the user in the wearing state.

The electric field communication terminal 120 can perform electric field communication by the same principle as described with reference to FIG. 3. When performing electric field communication, the transceiver 124, the first coupling electrode 125, and the second coupling electrode 126 have functions respectively corresponding to the transceiver 116, the second input/output terminal 116b, and the first input/output terminal 116a in FIG. 3. A portion of the human body in contact with the first coupling electrode 125 (such as the distal side of the wrist) functions as the transmission medium 130 in FIG. 3, and a portion of the human body in contact with the second coupling electrode 126 (the entire body excluding the distal side of the wrist) functions similarly to the terminal line 117 in FIG. 3.

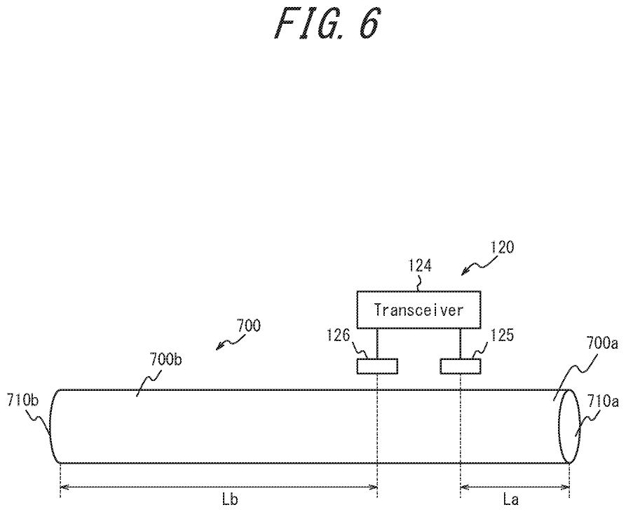

Here, the principle by which the human body functions as a transmission medium and a terminal line is described. FIG. 6 schematically illustrates the state in which the electric field communication terminal 120 is coupled to a dielectric 700. In FIG. 6, the dielectric 700 is illustrated schematically as being cylindrical.

As illustrated in FIG. 6, the cylindrical dielectric 700 has a first bottom (first end) 710a and a second bottom (second end) 710b. The height of the cylindrical dielectric 700 is greater than the diameter of the bottoms (a first bottom 710a and a second bottom 710b) of the dielectric 700. The height direction of the cylinder is also referred to as the longitudinal direction.

The electric field communication terminal 120 couples to the dielectric 700 so that the first coupling electrode 125 and the second coupling electrode 126 are side-by-side in the longitudinal direction of the dielectric 700. Here, it is assumed that the first coupling electrode 125 is coupled to be closer to the first bottom 710a, and the second coupling electrode 126 is coupled to be closer to the second bottom 710b.

In the dielectric 700 to which the electric field communication terminal 120 is coupled, the region from the position at which the first coupling electrode 125 is coupled towards the first bottom 710a is referred to as a first region 700a, and the region from the position at which the second coupling electrode 126 is coupled towards the second bottom 710b is referred to as a second region 700b. The height of the first region 700a (the length in the longitudinal direction) is referred to as La, and the height of the second region 700b as Lb. By the user coupling the first coupling electrode 125 and the second coupling electrode 126 of the electric field communication terminal 120 to the dielectric 700 at the below-described predetermined positions, the first region 700a functions as a transmission medium, and the second region 700b functions as a terminal line.

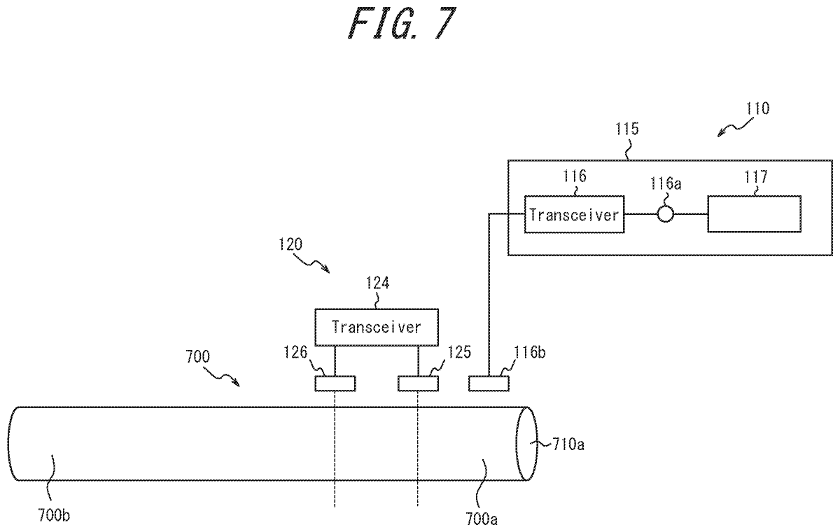

Here, the predetermined positions for the first region 700a to function as a transmission medium and the second region 700b to function as a terminal line are described. The electric field communication terminal 120 is coupled to a position on the dielectric 700 such that the length Lb is an electrical length of ((2n+1)×90) degrees. If the length Lb is an electrical length of ((2n+1)×90) degrees, then the information processing system 1 capable of electric field communication is established by the electric field communication terminal 120, the dielectric 700, and the information processing apparatus 110 upon the first region 700a coupling with the schematically illustrated second input/output terminal 116b formed by the body of the information processing apparatus 110, as illustrated in FIG. 7. In this case, by the principle explained with reference to FIG. 4, a standing wave is generated with a maximum voltage amplitude and zero current amplitude at the second bottom 710b of the second region 700b and zero voltage amplitude and maximum current amplitude at the end of the second region 700b where the second coupling electrode 126 is coupled. From the transceiver 124, current thus flows towards the second region 700b of the dielectric 700 through the second coupling electrode 126, and current flows towards the first region 700a through the first coupling electrode 125. Consequently, the electric field communication terminal 120 can communicate with the information processing apparatus 110 using the first region 700a as a transmission medium. In this way, the second region 700b has a similar function to that of the terminal line 117 illustrated in FIG. 3.

As explained with reference to FIG. 3, a certain advantage in high-frequency transmission is still obtained when the electrical length of the terminal line 117 is within a range of ±45 degrees of 90 degrees, i.e. when the phase of the reflected wave is greater than 90 degrees and less than 270 degrees. Therefore, coupling at a position such that the length Lb becomes an electrical length in a range of ((2n+1)×90±45) degrees is sufficient for the second region 700b to function as a terminal line.

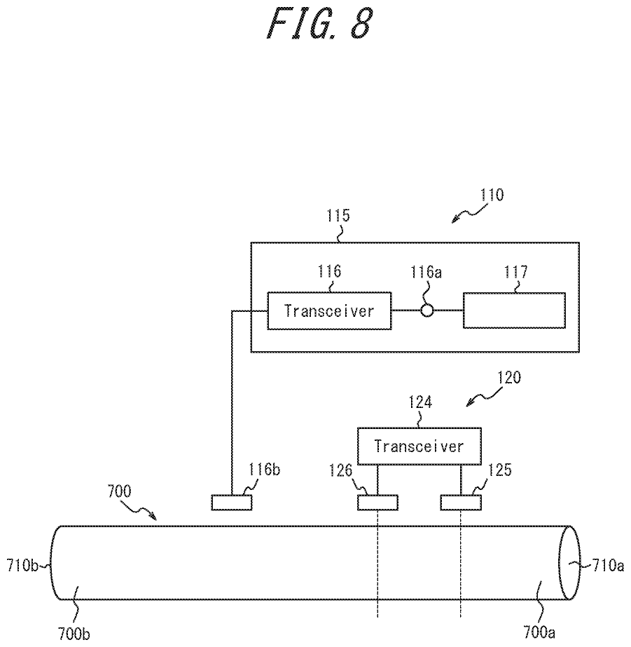

Here, the electric field communication terminal 120 is coupled to a position on the dielectric 700 such that the length La is an electrical length of (2n×90) degrees. If the length La were also an electrical length of ((2n+1)×90) degrees like the length Lb, then the first region 700a would function as a terminal line and the second region 700b would function as a transmission medium upon the second region 700b coupling with the second input/output terminal 116b of the information processing apparatus 110, as illustrated in FIG. 8. In other words, in this configuration, either the first region 700a or the second region 700b can function as a terminal line.

However, when the information processing apparatus 110 is coupled to the dielectric 700 at a position such that the length La of the first region 700a is an electrical length of (2n×90) degrees, the standing wave illustrated in FIG. 3 is not generated at the end on the side where the first coupling electrode 125 of the first region 700a is coupled. Consequently, the first region 700a does not function as a terminal line, and no virtual ground is formed, even if the second region 700b couples to the second input/output terminal 116b of the information processing apparatus 110, as illustrated in FIG. 8. This prevents the establishment of communication between the electric field communication terminal 120 and the information processing apparatus 110.

In this way, when the electric field communication terminal 120 is coupled at a position such that the length La of the first region 700a is an electrical length of (2n×90) degrees and the length Lb of the second region 700b is an electrical length of (2(n+1)×90) degrees, the second region 700b of the dielectric 700 functions as a terminal line, whereas the first region 700a of the dielectric 700 does not function as a terminal line. Hence, the electric field communication terminal 120 establishes communication when the second input/output terminal 116b of the information processing apparatus 110 is coupled to the first region 700a but does not establish communication when the second input/output terminal 116b is coupled to the second region 700b.

In this way, by the electric field communication terminal 120 coupling to a predetermined position of the dielectric 700, a region allowing establishment of communication and a region not allowing establishment of communication upon coupling with the body of the information processing apparatus 110, which is the second input/output terminal 116b, can be formed in the dielectric 700. In other words, the region allowing establishment of communication in the dielectric 700 can be restricted in this way. The region allowing establishment of communication can therefore be restricted when the electric field communication terminal 120 is coupled at the predetermined position on the dielectric 700. This reduces the likelihood of unintended communication and facilitates prevention of unintended information leaks. The electric field communication terminal 120 in the present embodiment improves security with respect to this point.

It suffices for the electric field communication terminal 120 to be coupled at a position where the length La of the first region 700a is such that no standing wave is generated in the first region 700a. It thus suffices for the electric field communication terminal 120 to be coupled at a position such that the length La is an electrical length in a range of (2n×90±45) degrees.

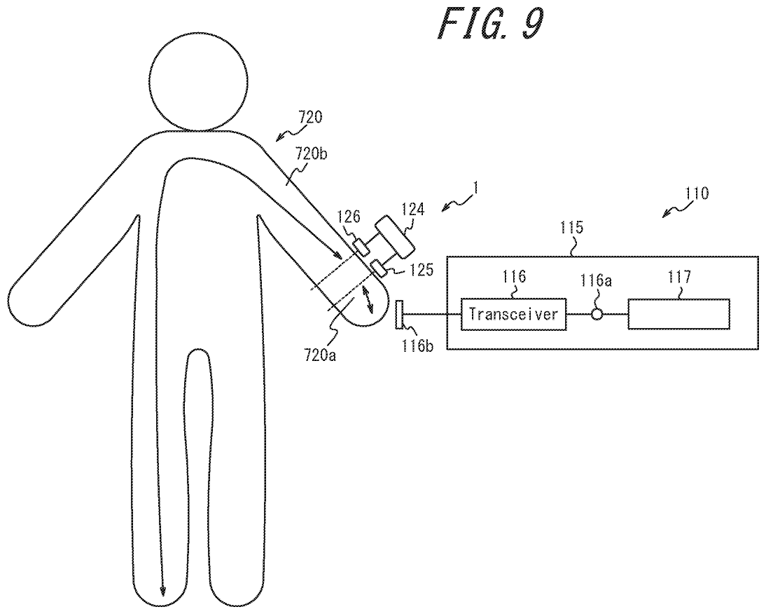

FIG. 9 illustrates an example of the information processing system 1 configured by coupling the electric field communication terminal 120 to a human body 720, which is a dielectric. As illustrated in FIG. 9, the first coupling electrode 125 and the second coupling electrode 126 are coupled to the human body 720 by the electric field communication terminal 120 being worn on the wrist or the like of a human body, for example. At this time, the first coupling electrode 125 and the second coupling electrode 126 couple to the human body 720 so as to be side-by-side in a direction from the torso side towards the distal side of the arm. The electric field communication terminal 120 may be formed as a wristband, an armband, or the like so as to be attachable to the wrist, the arm, or other body part when the electric field communication terminal 120 is coupled to the human body 720.

When the electric field communication terminal 120 is coupled to the human body 720, the electric field communication terminal 120 uses an electric field signal of a predetermined frequency so that the region from the first coupling electrode 125 coupled on the distal side to the end (for example, the fingertip) becomes the first region 700a illustrated in FIG. 6, and the region from the second coupling electrode 126 on the torso side to the entire arm, torso, and leg becomes the second region 700b illustrated in FIG. 6. The predetermined frequency may, for example, be 13.56 MHz. When the frequency of the electric field signal is 13.56 MHz, then coupling the second coupling electrode 126 to the human body 720 on the torso side near a wrist yields an electrical length of approximately 90 degrees as the length of the second region and an electrical length of less than 45 degrees as the length of the first region, supposing that the human body 720 is a typical adult height (such as 170 cm). Hereinafter, the frequency of the signal used by the electric field communication terminal 120 is assumed to be 13.56 MHz. Furthermore, the region from the first coupling electrode 125 on the distal side to the end (for example, the fingertip) is referred to as the distal side 720a of the human body 720, and the region from the second coupling electrode 126 on the torso side to the entire arm, torso, and leg is referred to as the torso side 720b of the human body 720.

When a fingertip, for example, of the human body 720 on which the electric field communication terminal 120 is worn touches the body of the information processing apparatus 110, then a standing wave is generated on the torso side 720b of the human body 720, forming a virtual ground. In other words, the torso side 720b functions as a terminal line. The distal side 720a functions as a transmission medium. Electric field communication is thus achieved between the information processing apparatus 110 and the electric field communication terminal 120 via the human body 720, which functions as a transmission medium.

In the present embodiment, the distal side 720a does not function as a terminal line, and hence communication is not established, when the torso side 720b of the human body 720 on which the electric field communication terminal 120 is worn couples to the second input/output terminal 116b. In other words, the information processing system 1 according to the present embodiment allows electric field communication while reducing the likelihood of unintended communication, thereby facilitating prevention of unintended information leaks and improving security.

In the information processing system 1 according to the present embodiment, electric field communication is performed between the information processing apparatus 110 and the electric field communication terminal 120 by the above-described principle. The information processing apparatus 110 receives predetermined information from the electric field communication terminal 120 by electric field communication. For example, the information processing apparatus 110 receives an ID stored in the storage 123. The controller 111 of the information processing apparatus 110 executes a predetermined process when detecting that a predetermined process has been executed on the operation interface and that information (such as an ID) acquired from the electric field communication terminal 120 satisfies a predetermined condition.

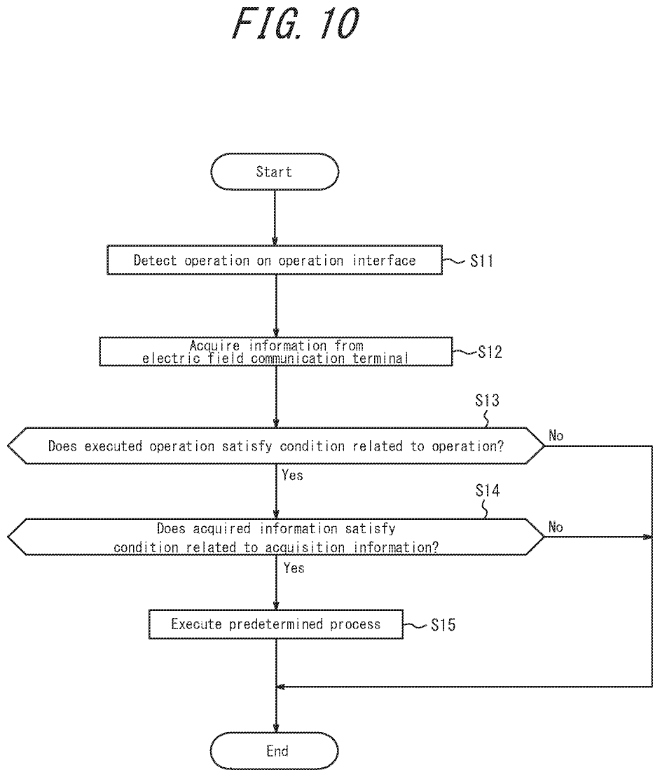

The process executed by the controller 111 is now described in detail. FIG. 10 is a flowchart illustrating an example of information processing by the controller 111 of the information processing apparatus 110.

The controller 111 executes a predetermined process, using information acquired by electric field communication, when detecting execution of a predetermined operation on the operation interface 112. In the present embodiment, the controller 111 executes the predetermined process when judging that the information acquired by electric field communication satisfies a predetermined condition related to acquisition information.

As an example, the case of the information processing apparatus 110 performing a login process as the predetermined process is described. It is assumed that the information processing apparatus 110 can be used when only a specific user is authenticated and logs in. IDs corresponding to users allowed to log into the information processing apparatus 110 are stored in the storage 113 of the information processing apparatus 110.

Suppose that the user wearing the electric field communication terminal 120 executes an operation on the operation interface 112. In this case, the operation interface 112 outputs a signal indicating content related to the executed operation to the controller 111. By acquiring the signal outputted by the operation interface 112, the controller 111 detects the operation executed on the operation interface 112 (step S11). When the operation interface 112 is configured by a keyboard, for example, the controller 111 can thereby detect which key was operated (pressed).

The information processing apparatus 110 causes the operation interface 112 to function as a coupling electrode for electric field communication by the input/output terminal of the communication module 115 being connected to a metal portion or a dielectric portion that includes the operation interface 112. For example, the keyboard can be caused to operate as a coupling electrode for electric field communication. When the user operates the operation interface 112, the information processing apparatus 110 performs electric field communication with the electric field communication terminal 120 using a human body as a transmission medium. Here, the keyboard is the coupling electrode. Hence, when the human body touches or is close to the keyboard that is the coupling electrode, for example when the user operates the keyboard, the information processing apparatus 110 performs electric field communication with the electric field communication terminal 120 using the human body as a transmission medium. The controller 111 acquires predetermined information stored in the storage 123 from the electric field communication terminal 120 by electric field communication (step S12). Here, the predetermined information is described as being the ID of the electric field communication terminal 120, i.e. the ID associated with the user.

The controller 111 can, for example, authenticate the user based on the operation detected in step S11 and the information acquired in step S12. In the present embodiment, the controller 111 performs authentication in step S13 and step S14.

Specifically, the controller 111 judges whether the operation detected in step S11 satisfies a condition related to an operation (step S13). The condition related to an operation is, for example, a predetermined condition related to an operation that the user is requested to execute for authentication. The condition related to an operation may, for example, be operation of a predetermined key on the keyboard (such as the Enter key or the space key). Here, the condition related to an operation is described as being an operation to press the Enter key.

When the controller 111 judges that the operation detected in step S11 satisfies a condition related to an operation (step S13: Yes), the controller 111 judges whether the information acquired in step S12 satisfies a condition related to acquisition information (step S14). The condition related to acquisition information is, for example, a condition for judging whether the information acquired from the electric field communication terminal 120 for performing authentication matches information that is registered in advance or the like.

For example, when an ID is acquired from the electric field communication terminal 120 in step S12 as the predetermined information, the controller 111 judges in step S14 whether the acquired ID matches an ID stored in advance in the storage 113 of the information processing apparatus 110. When the ID acquired from the electric field communication terminal 120 matches an ID stored in the storage 113, for example, the controller 111 judges that the condition related to acquisition information is satisfied. In this case, it can be judged that the user wearing the electric field communication terminal 120 is a legitimate user with login authority. When the ID acquired from the electric field communication terminal 120 does not match an ID stored in the storage 113, for example, the controller 111 judges that the condition related to acquisition information is not satisfied. In this case, it can be judged that the user wearing the electric field communication terminal 120 is an illegitimate user without login authority.

When the controller 111 judges that the information acquired in step S12 satisfies a condition related to acquisition information (step S14: Yes), the controller 111 executes a predetermined process (step S15). The predetermined process may, for example, be a process related to authentication of the user having succeeded. In other words, the predetermined process may be a login process, for example. When the information processing apparatus 110 is locked, for example, the predetermined process may be an unlocking process. The predetermined process may include a process to change the display of the display 114 in conjunction with the authentication having succeeded. Here, the process to change the display of the display 114 may be a process to notify the user of a screen indicating that authentication succeeded.

On the other hand, when the controller 111 judges that the operation detected in step S11 does not satisfy a condition related to an operation (step S13: No), the processing flow ends without execution of the predetermined process in step S15. When the controller 111 judges that the information acquired in step S12 does not satisfy a condition related to acquisition information (step S14: No), the processing flow ends without execution of the predetermined process in step S15.

In this way, the information processing apparatus 110 in the information processing system 1 according to the present embodiment executes a predetermined process when detecting execution of a predetermined operation on the operation interface 112 and judging that information acquired from the electric field communication terminal 120 satisfies a condition related to acquisition information. Consequently, when a user wearing an electric field communication terminal 120 with a user-associated ID not stored in advance in the storage 113, as described above, executes an operation on the operation interface 112, for example, a predetermined process (such as a login process) is not executed. Conversely, when a user wearing an electric field communication terminal 120 with a user-associated ID stored in advance in the storage 113 performs a predetermined operation on the operation interface 112, a predetermined process (such as a login process) is executed. This facilitates prevention of unauthorized logins by illegitimate users while allowing legitimate users to perceive a predetermined operation (for example, pressing the enter key) as though it were a login operation. In other words, a legitimate user can log in with a simple operation without the burden of entering a password or a PIN, for example. The information processing system 1 can thus be more convenient and useful for the user.

The information processing apparatus 110 also executes a predetermined process when, as described above, the operation executed on the operation interface 112 satisfies a condition related to an operation and the information acquired from the electric field communication terminal 120 by electric field communication satisfies a condition related to acquisition information. Therefore, if an illegitimate user were to wear an electric field communication terminal 120 with an ID associated with another user and perform an operation on the information processing apparatus 110, for example, the illegitimate user could not easily log into the information processing apparatus 110 without knowing the condition related to the operation by which the information processing apparatus 110 judges whether to execute the predetermined process. The information processing system 1 can thereby improve the security of the system.

In the present embodiment, the information processing apparatus 110 may store the information acquired from the electric field communication terminal 120 by electric field communication in the storage 113 in association with an operation executed on the operation interface 112. For example, the information processing apparatus 110 may store the ID acquired from the electric field communication terminal 120 in the storage 113 in association with the operation performed by the user on the keyboard constituting the operation interface 112. The operation performed by the user on the keyboard and stored in the storage 113 is, for example, an indication of which key was pressed on the keyboard. The information processing apparatus 110 can thereby record a log indicating which operation was executed by the user together with the ID of the electric field communication terminal 120 used by the user.

The information processing apparatus 110 is described as being a personal computer in the example above, but the information processing apparatus 110 is not limited to this example. For example, the information processing apparatus 110 may be configured as a machine tool for processing material such as metal, wood, or stone. When the information processing apparatus 110 is configured as a machine tool, then an operation button, operation lever, or the like for operating the machine tool, for example, functions as the operation interface 112. The entire machine tool, including the operation interface 112, may instead function as a coupling electrode for electric field communication. The user wearing the electric field communication terminal 120 performs an operation on the operation interface 112 to operate the machine tool. Electric field communication takes place at this time between the electric field communication terminal 120 and the information processing apparatus 110 that is configured as a machine tool. The machine tool does not begin machining, as the predetermined process, unless the user operating the operation interface 112 is a user associated with an ID stored in advance. This configuration makes it easier to prevent operation of the machine tool by a non-registered user, for example. In the case of a machine tool that requires the user to have a particular skill, it is possible to grant the right to use the machine tool only to users certified as having the particular skill. In the case of a machine tool that requires complex operations, for example, the machine tool does not operate unless the user performs a predetermined operation (such as operating a plurality of operation buttons or operation levers in a predetermined order). This makes it easier to prevent the machine tool from malfunctioning. Disasters or accidents due to malfunctioning of the machine tool are therefore easier to prevent.

### Second Embodiment

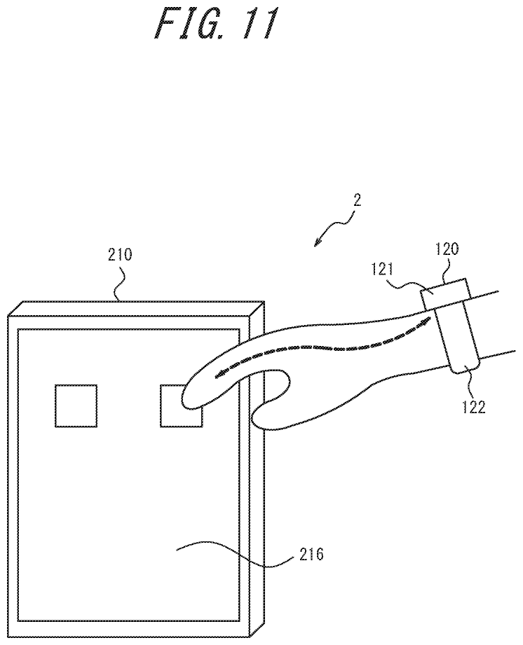

FIG. 11 is a schematic diagram of an information processing system 2 according to a second embodiment of the present disclosure. The information processing system 2 includes an information processing apparatus 210 and an electric field communication terminal 120. Since the remaining configuration of the electric field communication terminal 120 is similar to that of the first embodiment, a detailed explanation is omitted here.

The information processing apparatus 210 in the present embodiment is described below as being implemented by a display apparatus including a touch panel 216. Specifically, the information processing apparatus 210 may be configured by a mobile phone, a tablet, an electronic sign, or the like. The information processing apparatus 210 is not, however, limited to these examples and may be implemented by any apparatus that has the functions described in the present embodiment.

The touch panel 216 detects contact by the user's finger, a pen, a stylus pen, or the like. Any detection method may be used in the touch panel 216, such as a capacitive system, a resistive film system, a surface acoustic wave system (or an ultrasonic wave system), an infrared system, an electromagnetic induction system, a load detection system, or the like. The touch panel 216 may be configured by a touchscreen display that also functions as a display. In the present embodiment, the touch panel 216 is described below as being configured as a touchscreen display.

In the present embodiment, the user can purchase a product over the Internet (online shopping) using the information processing apparatus 210. In other words, the information processing apparatus 210 in the present embodiment can display products purchasable over the Internet based on user operation input on the touch panel 216 and receive input of a product the user wishes to purchase. The information processing apparatus 210 can execute processing for electronic payment using electronic money.

The information processing apparatus 210 is configured to be capable of electric field communication using electric field signals. An input/output terminal of a communication module 215 inside the information processing apparatus 210 is connected to a ground, a housing, or the like of the information processing apparatus 210. The information processing apparatus 210 thus operates as a coupling electrode for electric field communication. In other words, the information processing apparatus 210 and the electric field communication terminal 120 can perform electric field communication using a human body (user), which is a dielectric, as a transmission medium. Accordingly, electric field communication occurs when the user wearing the electric field communication terminal 120 touches the information processing apparatus 210. A portion of the information processing apparatus 210, such as the touch panel 216 alone, may be configured to be capable of electric field communication.

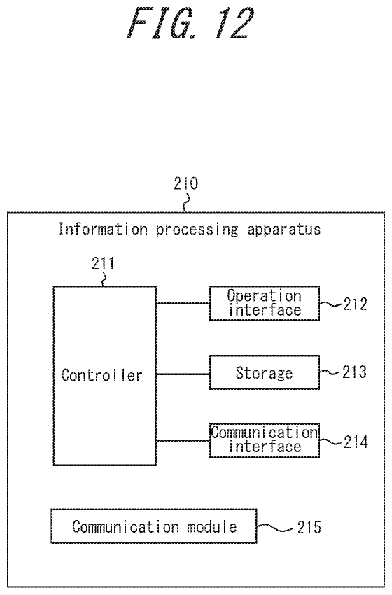

FIG. 12 is a functional block diagram schematically illustrating the configuration of the information processing apparatus 210 in FIG. 11. As illustrated in FIG. 12, the information processing apparatus 210 includes a controller 211, an operation interface 212, a storage 213, a communication interface 214, and a communication module 215.

The controller 211 is a processor that controls and manages the information processing apparatus 210 overall, starting with the functional blocks of the information processing apparatus 210. The controller 211 is a processor, such as a CPU, that executes a program prescribing control procedures. Such programs are, for example, stored in the storage 213 or on an external storage medium.

When the controller 211 detects that a predetermined process has been performed on the operation interface 212, the controller 211 executes a predetermined process using information acquired from the electric field communication terminal 120 by electric field communication. Details of the processes executed by the controller 211 are provided below.

The operation interface 212 receives user operations. In the present embodiment, the operation interface 212 is, for example, configured by the touch panel 216. In the present embodiment, the touch panel 216 is configured as a touchscreen display. The operation interface 212 therefore also functions as a display that displays information. The operation interface 212 is not, however, limited to the touch panel 216 and may be configured by any member capable of receiving user operations.

In response to control by the controller 211, various information for online shopping is displayed on the touch panel 216 forming the operation interface 212. An input button, for example, for searching and choosing products is displayed on the touch panel 216. Information related to products, for example, is displayed on the touch panel 216. The information related to products includes, for example, the product name, product price, product description, product photograph, and the like. An input button for selecting to purchase a product, for example, is displayed on the touch panel 216. The letters “purchase” or the like may, for example, be displayed on the input button for selecting to purchase a product.

The communication interface 214 exchanges a variety of information by communicating in a wired or wireless manner with an external apparatus, such as a server. The communication interface 214 receives information related to products sold online from the external apparatus and transmits information related to the purchase of a product inputted by the user to the external apparatus.

The configuration and functions of the storage 213 and the communication module 215 are similar to those of the storage 113 and the communication module 115 of the first embodiment. Hence, a detailed description thereof is omitted here. The ID of each electric field communication terminal 120, along with information related to the purchase history of the user associated with the ID and information related to electronic money, is stored in the storage 213 in the present embodiment. The information related to the purchase history is information related to products purchased by the user in the past and may include the time of purchase, details of the purchased products, and the like. The information related to electronic money may include the remaining balance of electronic money.

The information processing apparatus 210 and the electric field communication terminal 120 can perform electric field communication by the same principle as described in the first embodiment.

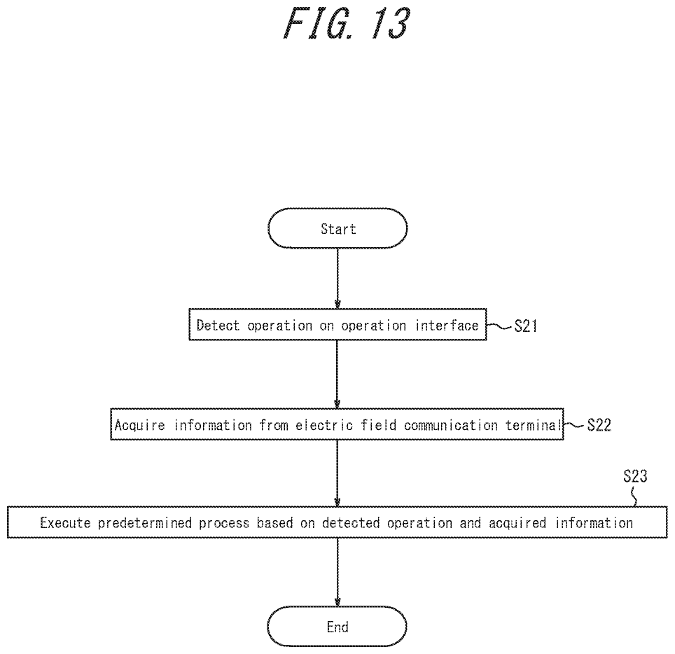

Next, the processes executed by the controller 211 are described in detail. FIG. 13 is a flowchart illustrating an example of information processing by the controller 211 of the information processing apparatus 210.

Suppose that the user wearing the electric field communication terminal 120 executes an operation on the operation interface 212. In this case, the operation interface 212 outputs a signal indicating content related to the executed operation to the controller 211. By acquiring the signal outputted by the operation interface 212, the controller 211 detects the operation executed on the operation interface (step S21). When the operation interface 212 is configured by the touch panel 216, for example, the controller 211 can thereby detect which area was operated (touched). An input button for executing a predetermined process is displayed on the touch panel 216, for example. The controller 211 can identify the input button selected by the user by detecting the area on the touch panel 216 that was operated.

When the user operates the operation interface 212, the information processing apparatus 210 performs electric field communication with the electric field communication terminal 120 using a human body as a transmission medium. The controller 211 acquires predetermined information stored in the storage 123 from the electric field communication terminal 120 by electric field communication (step S22).

The controller 211 executes a predetermined process based on the operation detected in step S21 and the information acquired in step S22 (step S23).

An example of the predetermined process in step S23 is now described. For example, suppose the user touches the input button on the touch panel 216 to search for or select a product. In step S21, the controller 211 in this case can detect that the user operated the input button to search for or select a product. During electric field communication in step S22, the controller 211 can acquire information related to the purchase history from the electric field communication terminal 120 as predetermined information. Based on the operation of the input button to search for or select a product and the information related to the purchase history, the controller 211 in this case can execute a predetermined process in step S23 by executing a process to display content corresponding to the acquired information (here, the information related to the purchase history) on the touch panel 216. In the example here, the controller 211 can execute a predetermined process such as a process to search for products to recommend that the user purchase and display the products on the touch panel 216. The products to recommend that the user purchase may, for example, include products similar to those purchased by the user in the past or products purchased by other users who purchased a product that the user purchased in the past. The controller 211 itself, for example, may search for the products to recommend that the user purchase. An external apparatus that has received information related to the purchase history from the information processing apparatus 210 via the communication interface 214 may also search for the products to recommend that the user purchase. In this case, the controller 211 can display the search result received from the external apparatus on the touch panel 216.

It is thought that when the user operates the input button to search for or select a product, the user is going to purchase a product. In this case, products that the user is likely to purchase can be displayed on the touch panel 216 by displaying products based on the user's purchase history, as described above. Information of products that the user would like to purchase is therefore more likely to be displayed. Product vendors can also present users with products that they are likely to purchase. The information processing system 2 of the present embodiment is therefore more useful for both users and vendors.

Another example of the predetermined process in step S23 is now described. For example, suppose the user finishes selecting a product he wishes to purchase and touches the input button on the touch panel 216 to purchase the product. In step S21, the controller 211 in this case can detect that the user operated the input button to purchase a product. During electric field communication in step S22, the controller 211 can acquire information related to electronic money from the electric field communication terminal 120 as predetermined information. Based on the operation of the input button to purchase a product and the information related to electronic money, the controller 211 in this case can perform electronic payment using electronic money in step S23 as the predetermined process. In other words, the user can pay by operating the input button to purchase a product. For example, in a known system for paying using an IC card, the user pays by operating an input button to purchase a product and then swiping an IC card storing information related to electronic money in a reader/writer. In other words, to purchase a product, the user needs to operate the input button to purchase a product and then swipe the IC card. In the information processing system 2 according to the present embodiment, however, the information processing apparatus 210 can access information, stored in the electric field communication terminal 120, by electric field communication and perform electronic payment when the user presses the input button for purchasing a product, as described above. Hence, the user can pay electronically without performing an operation for electronic payment, such as swiping an IC card. The information processing system 2 of the present embodiment is therefore more useful.

### Third Embodiment

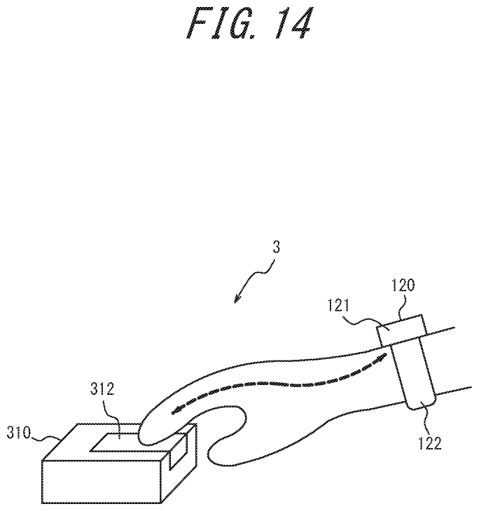

FIG. 14 is a schematic diagram of an information processing system 3 according to a third embodiment of the present disclosure. The information processing system 3 includes an information processing apparatus 310 and an electric field communication terminal 120. Since the remaining configuration of the electric field communication terminal 120 is similar to that of the first embodiment, a detailed explanation is omitted here.

In the present embodiment, the information processing apparatus 310 acquires biological information of the user. The biological information is information related to a fingerprint of the user (fingerprint data), for example. In other words, the information processing apparatus 310 may be implemented as a fingerprint reading apparatus that includes a biological information acquisition interface 312 capable of reading fingerprint data of a user. The biological information is not limited to fingerprint data of the user. For example, the biological information may be other information related to the user's body, such as the vein pattern of the user's palm or finger. In the present embodiment, the biological information is described as being fingerprint data.

The information processing apparatus 310 is configured to be capable of electric field communication using electric field signals. An input/output terminal of a communication module 315 inside the information processing apparatus 310 is connected to the housing of the information processing apparatus 310, for example. The information processing apparatus 310 thus operates as a coupling electrode for electric field communication. In other words, the information processing apparatus 310 and the electric field communication terminal 120 can perform electric field communication using a human body (user), which is a dielectric, as a transmission medium.

Accordingly, electric field communication occurs when the user wearing the electric field communication terminal 120 touches the information processing apparatus 310. A portion of the information processing apparatus 310, such as the biological information acquisition interface 312 alone, may be configured to be capable of electric field communication.

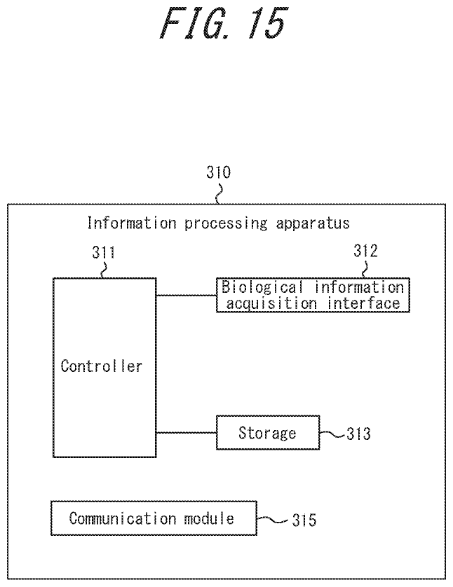

FIG. 15 is a functional block diagram schematically illustrating the configuration of the information processing apparatus 310 in FIG. 14. As illustrated in FIG. 15, the information processing apparatus 310 includes a controller 311, the biological information acquisition interface 312, a storage 313, and the communication module 315.

The controller 311 is a processor that controls and manages the information processing apparatus 310 overall, starting with the functional blocks of the information processing apparatus 310. The controller 311 is a processor, such as a CPU, that executes a program prescribing control procedures. Such programs are, for example, stored in the storage 313 or on an external storage medium.

The controller 311 executes a predetermined process when judging that the biological information acquired by the biological information acquisition interface 312 satisfies a condition related to biological information and judging that information acquired by electric field communication satisfies a condition related to acquisition information. In the present embodiment, the predetermined process is described below as being a user authentication success process. The authentication success process may, for example, include a process to output information indicating that authentication of the user succeeded. The predetermined process is not, however, limited to a user authentication success process. Details of the processes executed by the controller 311 are provided below.

The biological information acquisition interface 312 acquires biological information of the user. In the present embodiment, the biological information acquisition interface 312 is configured by a fingerprint sensor capable of acquiring fingerprint data of the user. The biological information acquisition interface 312 is, for example, configured by an optical type, semiconductor type (e.g. capacitive, thermosensitive, or electric field type), or other type of well-known fingerprint sensor. The biological information acquisition interface 312 transmits acquired biological information to the controller 311. The user can, for example, touch a finger to the biological information acquisition interface 312 to cause the biological information acquisition interface 312 to read biological information. The biological information acquisition interface 312 is configured to be capable of electric field communication with the electric field communication terminal 120 through the communication module 315.

The configuration and functions of the storage 313 and the communication module 315 are similar to those of the storage 113 and the communication module 115 of the first embodiment. Hence, a detailed description thereof is omitted here. In the present embodiment, an ID of the electric field communication terminal 120 that performs authentication is stored in the storage 313 in association with fingerprint data of the user associated with the ID.

The information processing apparatus 310 and the electric field communication terminal 120 can perform electric field communication by the same principle as described in the first embodiment.

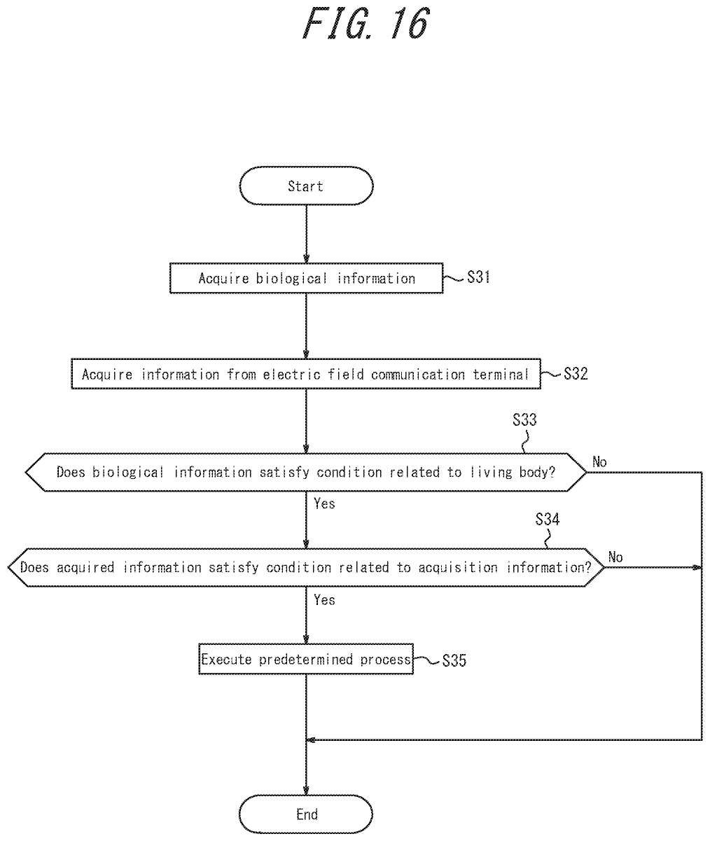

Next, the processes executed by the controller 311 are described in detail. FIG. 16 is a flowchart illustrating an example of information processing by the controller 311 of the information processing apparatus 310.

Suppose that a user wearing the electric field communication terminal 120 touches a finger to the biological information acquisition interface 312. In this case, the biological information acquisition interface 312 acquires biological information from the touching finger and transmits the acquired biological information to the controller 311. The controller 311 acquires biological information from the biological information acquisition interface 312 (step S31).

When the user touches a finger to the biological information acquisition interface 312, the information processing apparatus 310 performs electric field communication with the electric field communication terminal 120 using a human body as a transmission medium. The controller 311 acquires predetermined information stored in the storage 123 from the electric field communication terminal 120 by electric field communication (step S32). Here, the predetermined information is described as being the ID of the electric field communication terminal 120, i.e. the ID associated with the user.

As the predetermined process, the controller 311 can, for example, authenticate the user based on the biological information acquired in step S31 and the information acquired in step S32.

In other words, the controller 311 judges whether the biological information acquired in step S31 satisfies a condition related to biological information (step S33). The condition related to biological information is, for example, a condition for judging whether the biological information matches biological information of the user stored in advance in the storage 313 of the information processing apparatus 310.

For example, the controller 311 judges in step S33 whether the acquired biological information matches the biological information of the user stored in advance in the storage 313. The controller 311 judges that the condition related to biological information is satisfied when the acquired biological information matches the biological information of the user stored in advance in the storage 313. In this case, it can be judged that the user who touched a finger to the biological information acquisition interface 312 is a legitimate user registered in advance. The controller 311 judges that the condition related to biological information is not satisfied when the acquired biological information does not match the biological information of the user stored in advance in the storage 313. In this case, it can be judged that the user who touched a finger to the biological information acquisition interface 312 is an illegitimate user not registered in advance.

When the controller 311 judges that the biological information satisfies a condition related to a living body (step S33: Yes), the controller 311 judges whether the information acquired in step S32 satisfies a condition related to acquisition information (step S34). The condition related to acquisition information is, for example, a condition for judging whether the information acquired from the electric field communication terminal 120 for performing authentication matches information that is registered in advance or the like. During the judgment of the condition related to acquisition information, the controller 311 may judge whether the ID associated with the biological information acquired in step S31 matches the ID of the electric field communication terminal 120 acquired in step S32.

The controller 311 can judge that the condition related to biological information is satisfied when the ID associated with the biological information acquired in step S31 matches the ID of the electric field communication terminal 120 acquired in step S32. In this case, it can be judged that a legitimate user registered in advance is wearing his own electric field communication terminal 120 and touching a finger to the biological information acquisition interface 312. Conversely, the controller 311 can judge that the condition related to acquisition information is not satisfied when the ID associated with the biological information acquired in step S31 does not match the ID of the electric field communication terminal 120 acquired in step S32. In this case, it can be judged that the electric field communication terminal 120 worn by the user is not registered, or that even if it is registered, it is being worn by a user not associated with the electric field communication terminal 120.

When the controller 311 judges that the acquired information satisfies a condition related to acquisition information (step S34: Yes), the controller 311 executes a predetermined process (step S35). The predetermined process is, for example, a user authentication success process.

On the other hand, when the controller 311 judges that the biological information does not satisfy a condition related to a living body (step S33: No), the processing flow ends without execution of the predetermined process in step S35. When the controller 311 judges that the acquired information does not satisfy a condition related to acquisition information (step S34: No), the processing flow ends without execution of the predetermined process in step S35.

The information processing apparatus 310 can be used for a variety of purposes by being implemented in various apparatuses. For example, when the information processing apparatus 310 is installed in an automated/automatic teller machine (ATM), the ATM may be controlled in a state allowing financial transactions when the information processing apparatus 310 has executed the authentication success process. When the information processing apparatus 310 is implemented in a security apparatus provided at the entrance to a room, building, or the like, the entrance to the room or building may be unlocked when the information processing apparatus 310 has executed the authentication success process. Apart from the examples illustrated here, the information processing apparatus 310 may be mounted in any apparatus that requires identification.

In this way, the information processing apparatus 310 in the information processing system 3 according to the present embodiment executes a predetermined process when judging that the biological information acquired by the biological information acquisition interface 312 satisfies a condition related to a living body and judging that information acquired by electric field communication satisfies a condition related to acquisition information. The information processing apparatus 310 therefore does not execute a predetermined process when at least one of the condition related to a living body and the condition related to acquisition information is not satisfied. Since the information processing apparatus 310 thus executes a predetermined process when a plurality of conditions is satisfied, security is improved as compared to the case of executing a predetermined process depending only on one condition. Moreover, when the user touches a finger to the biological information acquisition interface 312, the information processing apparatus 310 acquires biological information and also accesses the electric field communication terminal 120 to acquire information. In other words, while the user is performing one operation, a plurality of pieces of information used in the aforementioned plurality of conditions can be acquired. The user is therefore only required to perform one operation for authentication and does not feel irritated. In this way, the user is unlikely to become irritated with the information processing system 3, and security is also improved, thereby improving usefulness.

The information processing apparatus 310 does not perform a predetermined process if an illegitimate user wears another user's electric field communication terminal 120 and attempts to perform authentication using the information processing apparatus 310, because the condition related to biological information is not satisfied. Furthermore, even if an illegitimate user fraudulently obtains another user's fingerprint, the information processing apparatus 310 does not perform a predetermined process unless the other user's electric field communication terminal 120 is used. In this way, the information processing apparatus 310 does not execute a predetermined process even if biological information or the electric field communication terminal 120 is fraudulently used. This increases security as compared to the case of the process being executed when one of these is fraudulently used.

In the present embodiment, the ID of the electric field communication terminal 120 that performs authentication has been described as being stored in the storage 313 of the information processing apparatus 310 in association with fingerprint data of the user associated with the ID. The fingerprint data of the user, however, is not necessarily stored in the storage 313 of the information processing apparatus 310. The fingerprint data of the user may, for example, be stored in the storage 123 of the electric field communication terminal 120.

In this case, the information processing apparatus 310 acquires both the ID and the fingerprint data used to judge whether the condition related to a living body is satisfied from the electric field communication terminal 120 in step S32. In step S33, the information processing apparatus 310 can compare the fingerprint data acquired from the biological information acquisition interface 312 in step S31 with the fingerprint information of the user acquired from the electric field communication terminal 120 in step S32 to judge whether a condition related to a living body is satisfied. With this configuration as well, the information processing system 3 can avoid making the user feel irritated while also improving security, as described above, and is therefore more useful.

The information processing apparatus 310 does not need to store information used for judging whether a condition related to a living body is satisfied in the storage 313 when, in this way, the information used to judge whether the condition related to a living body is stored in the electric field communication terminal 120, and the information processing apparatus 310 uses electric field communication to acquire the information used for judging whether the condition related to a living body is satisfied. A malicious third party, for example, can therefore be prevented from accessing the information processing apparatus 310 and acquiring the information, such as a user's personal fingerprint data, that is used to judge whether the condition related to a living body is satisfied. The burden on the manager of the information processing apparatus 310 for managing a user's personal fingerprint data or the like can therefore be reduced. The burden on users for registering their own fingerprint data in advance to use the information processing system 3 can also be reduced for users planning on using the information processing system 3. The information processing system 3 can thereby be made even more useful.

### Fourth Embodiment

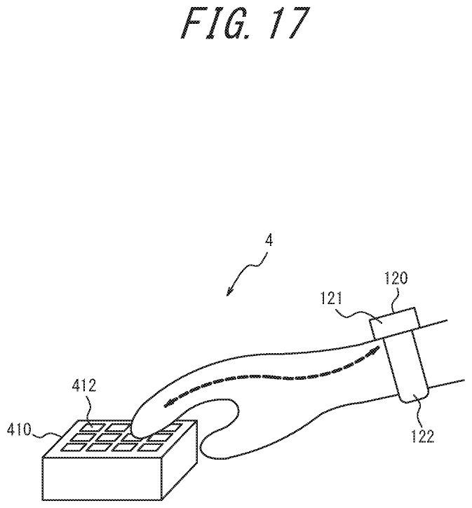

FIG. 17 is a schematic diagram of an information processing system 4 according to a fourth embodiment of the present disclosure. The information processing system 4 includes an information processing apparatus 410 and an electric field communication terminal 120.

In the present embodiment, the electric field communication terminal 120 has a function corresponding to a credit card with an IC chip. The user can, for example, use the electric field communication terminal 120 for third-party payment by a credit card company. Information corresponding to the information of a credit card with an IC chip is stored in the storage 123 of the electric field communication terminal 120. For example, the user's account number, expiration date, and the like may be stored in the storage 123. Since the functional units of the electric field communication terminal 120 may be similar to those of the first embodiment, a detailed explanation is omitted here.

In the present embodiment, an information processing apparatus 410 is, for example, configured by a point-of-sale terminal that submits an inquiry to a credit card company to confirm the validity of a credit card. The information processing apparatus 410 includes an operation interface 412 that, for example, is configured by keys for numerical input (numeric keypad). The operation interface 412 of the information processing apparatus 410 is used to input a personal identification number (PIN) when paying for a purchased product.

The information processing apparatus 410 is configured to be capable of electric field communication using electric field signals. An input/output terminal of a communication module 415 inside the information processing apparatus 410 is connected to the housing of the information processing apparatus 410, for example. The information processing apparatus 410 thus operates as a coupling electrode for electric field communication. In other words, the information processing apparatus 410 and the electric field communication terminal 120 can perform electric field communication using a human body (user), which is a dielectric, as a transmission medium. Accordingly, electric field communication occurs when the user wearing the electric field communication terminal 120 touches the information processing apparatus 410. A portion of the information processing apparatus 410, such as the operation interface 412 alone, may be configured to be capable of electric field communication.

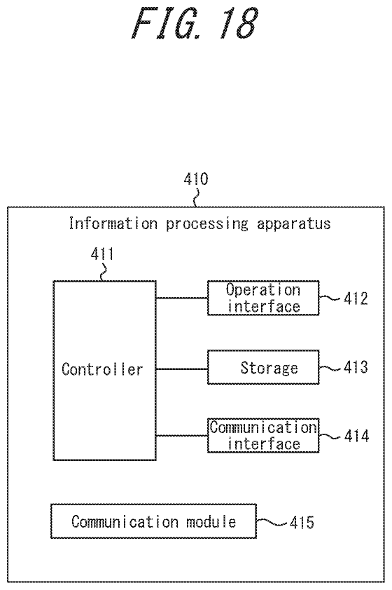

FIG. 18 is a functional block diagram schematically illustrating the configuration of the information processing apparatus 410 in FIG. 17. As illustrated in FIG. 18, the information processing apparatus 410 includes a controller 411, an operation interface 412, a storage 413, a communication interface 414, and a communication module 415.

The controller 411 is a processor that controls and manages the information processing apparatus 410 overall, starting with the functional blocks of the information processing apparatus 410. The controller 411 is a processor, such as a CPU, that executes a program prescribing control procedures. Such programs are, for example, stored in the storage 413 or on an external storage medium.

When the controller 411 detects that a predetermined process has been performed on the operation interface 412, the controller 411 executes a predetermined process using information acquired from the electric field communication terminal 120 by electric field communication. Details of the processes executed by the controller 411 are provided below.

The operation interface 412 receives user operations. In the present embodiment, the operation interface 412 is, for example, configured by a numeric keypad. The operation interface 412 is not, however, limited to a numeric keypad and may be configured by any member capable of receiving user operations.

The communication interface 414 exchanges a variety of information by communicating in a wired or wireless manner with an external apparatus, such as a server. For example, the communication interface 414 communicates with a server managed by a financial institution.

The configuration and functions of the storage 413 and the communication module 415 are similar to those of the storage 113 and the communication module 115 of the first embodiment. Hence, a detailed description thereof is omitted here.

The information processing apparatus 410 and the electric field communication terminal 120 can perform electric field communication by the same principle as described in the first embodiment.

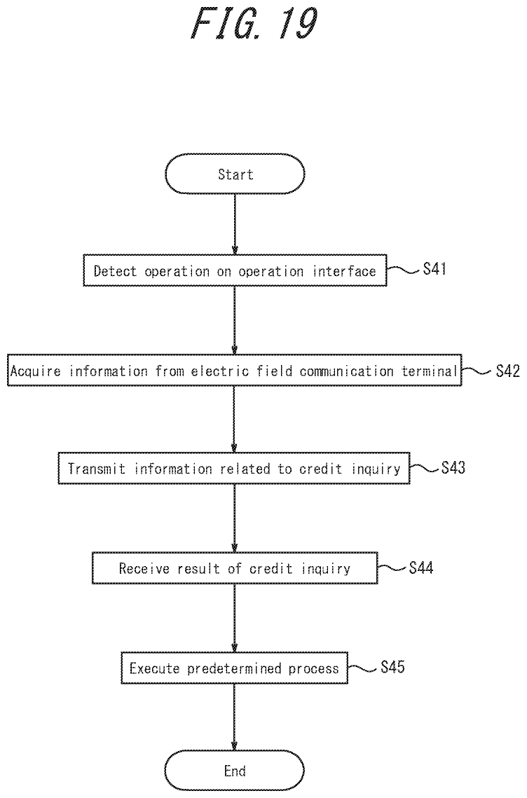

Next, the processes executed by the controller 411 are described in detail. FIG. 19 is a flowchart illustrating an example of information processing by the controller 411 of the information processing apparatus 410.

Suppose that the user wearing the electric field communication terminal 120 executes an operation to input the PIN on the operation interface 412 to pay for a product. In this case, the operation interface 412 outputs a signal indicating content related to the executed operation to the controller 411. By acquiring the signal outputted by the operation interface 412, the controller 411 detects the operation executed on the operation interface 412 (step S41). The controller 411 can thereby recognize the PIN that was inputted.

When the user operates the operation interface 412, the information processing apparatus 410 performs electric field communication with the electric field communication terminal 120 using a human body as a transmission medium. The controller 411 acquires predetermined information stored in the storage 123 from the electric field communication terminal 120 by electric field communication (step S42). The predetermined information is, for example, the above-described account number and the like of the user.

Through the communication interface 414, the controller 411 then transmits information related to a credit inquiry to a server managed by a financial institution (step S43). The information related to a credit inquiry may include the information inputted by the user operation in step S41 (such as the PIN) and information acquired from the electric field communication terminal 120 in step S42 (such as the account number). The information related to a credit inquiry may, for example, include a separately inputted cost of the product the user is attempting to purchase.

After receiving the information related to a credit inquiry, the server performs a credit inquiry by checking whether the electric field communication terminal 120 functioning in lieu of a credit card is valid, whether the cost of the product exceeds the credit limit, and the like. The server transmits the result of the credit inquiry to the information processing apparatus 410. The information processing apparatus 410 receives the result of the credit inquiry through the communication interface 414 (step S44).

The controller 411 executes a predetermined process based on the result of the credit inquiry (step S45). The predetermined process is, for example, a payment process.

To pay with a credit card, a user has sometimes needed to hand his credit card to a clerk for the clerk to read the credit card information with a point-of-sale terminal. In this case, the clerk or the like could acquire the card information by skimming or other means. With the information processing system 4 of the present embodiment, however, the user pays by inputting the PIN while wearing the electric field communication terminal 120 that has a function corresponding to a credit card. At this time, the information processing apparatus 410 configured as a point-of-sale terminal can read information by electric field communication. The information processing system 4 of the present embodiment can therefore reduce the probability of information being obtained by a third party. Security therefore improves. Even if a third party were to peek when the user enters the PIN, the third party could not pay by credit without wearing the electric field communication terminal 120. The risk of payment by credit by someone other than the legitimate user can therefore be reduced.

Embodiments of the present disclosure have been described in detail. A person of ordinary skill in the art, however, could make modifications or substitutions to the above embodiments without departing from the scope of the present disclosure. In other words, the present disclosure is not limited to the above embodiments, and a variety of modifications and changes are possible. For example, the functions and the like included in the various components may be reordered in any logically consistent way. Furthermore, components may be combined into one or divided.

The matter disclosed in the present disclosure is not intended to be all-encompassing. That is, the present disclosure does not deny the existence of subject matter not claimed in the present disclosure, i.e. the existence of subject matter of a later divisional application or subject matter to be added by amendment.

The present disclosure includes examples for the purpose of illustration but is not to be considered limited by the content of such examples.

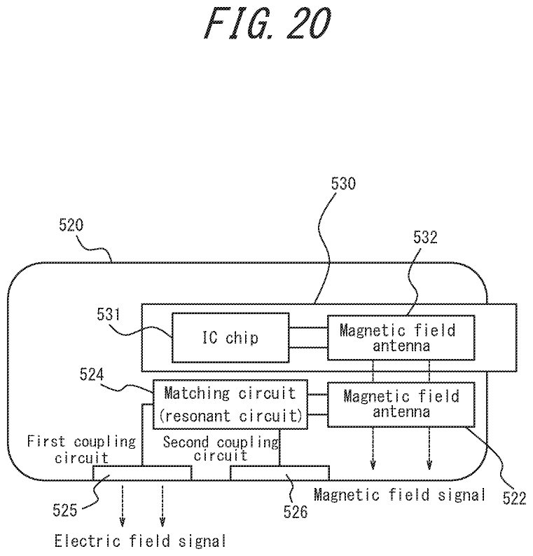

For example, in the first through fourth embodiments, the electric field communication terminal 120 may be configured to include a card holder into which a contactless IC card capable of magnetic field communication can be inserted. FIG. 20 is a functional block diagram illustrating the schematic configuration of a modification to an electric field communication terminal, specifically a functional block diagram of a card holder 520 with a contactless IC card 530 inserted therein.

The card holder 520 corresponds to the body 121 of the electric field communication terminal 120 in the first through fourth embodiments. The wearable portion 122 is attached to the card holder 520 and is configured to be wearable by a human body. The card holder 520 includes an insertion portion (groove) into which the contactless IC card 530 can be inserted. The user uses the card holder 520 with the contactless IC card 530 inserted in the insertion portion.

The contactless IC card 530 is a card-type magnetic field communication apparatus capable of transmitting and receiving information to and from a reader/writer by magnetic field communication. The contactless IC card 530 includes an IC chip 531, which stores predetermined information and controls magnetic field communication processing in the contactless IC card 530, and a magnetic field antenna 532 capable of communicating with the reader/writer by magnetic field signals. The user of the contactless IC card 530 can perform magnetic field communication by swiping the contactless IC card 530 at the communication position of the reader/writer.

The card holder 520 includes a magnetic field antenna 522, a matching circuit (resonant circuit) 524, a first coupling electrode 525, and a second coupling electrode 526.

The magnetic field antenna 522 is arranged at a position in the card holder 520 allowing reception of magnetic field signals from the magnetic field antenna 532 of the contactless IC card 530 when the contactless IC card 530 is inserted in the insertion portion. The magnetic field antenna 522 is connected to the matching circuit 524. When a magnetic field signal transmitted by the magnetic field antenna 532 is received in the magnetic field antenna 522, a control signal to be provided to the matching circuit 524 is generated on the basis of the received magnetic field signal. The control signal generated in the magnetic field antenna 522 is provided to the matching circuit 524.

The matching circuit 524 is connected to the magnetic field antenna 522. The matching circuit 524 is a circuit for matching impedance. The matching circuit 524 can, for example, be constituted by a known LC circuit combining a capacitor, an inductor, and the like. The matching circuit 524 is connected to the first coupling electrode 525 and the second coupling electrode 526.

The first coupling electrode 525 corresponds to the first coupling electrode 125, and the second coupling electrode 526 corresponds to the second coupling electrode 126, of the electric field communication terminal 120. The first coupling electrode 525 and the second coupling electrode 526 are disposed at positions in contact with a user (human body) when the user is wearing the card holder 520. In other words, the first coupling electrode 525 and the second coupling electrode 526 are in a state of being electrically coupled to the user when the user is wearing the card holder 520.

When the user is wearing the card holder 520 with the contactless IC card 530 inserted therein and touches the information processing apparatus described in the first through fourth embodiments, the magnetic field signal of the contactless IC card 530 in the card holder 520 is converted to an electric field signal. The distal side from the portion coupled to the first coupling electrode 525 functions as a transmission medium, and the torso side from the portion coupled to the second coupling electrode 526 functions as a terminal line. A system corresponding to the information processing system in the first through fourth embodiments is thereby implemented.

By the contactless IC card 530 being configured to be insertable, the user can select whether the perform magnetic field communication with the contactless IC card 530 or electric field communication by inserting the contactless IC card 530 in the card holder 520.

### REFERENCE SIGNS LIST

1, 2, 3, 4 Information processing system
110, 210, 310, 410 Information processing apparatus
111, 211, 311, 411 Controller
112, 212, 412 Operation interface
113, 123, 213, 313, 413 Storage
114 Display
115, 215, 315, 415 Communication module
116 Transceiver
116a First input/output terminal
116b Second input/output terminal
117 Terminal line
117a, 117b End
120 Electric field communication terminal
121 Body
122 Wearable portion
124 Transceiver
125, 525 First coupling electrode
126, 526 Second coupling electrode
130 Transmission medium
214, 414 Communication interface
216 Touch panel
312 Biological information acquisition interface
520 Card holder
522, 532 Magnetic field antenna
524 Matching circuit
531 IC chip
700 Dielectric
700a First region
700b Second region
710a First bottom
710b Second bottom
720 Human body
720a Distal side
720b Torso side

1. An information processing apparatus comprising:
an operation interface configured to receive an operation by a user and to be capable of electric field communication with an electric field communication terminal; and
a controller configured to execute a predetermined process, using information acquired by electric field communication, when detecting execution of a predetermined operation on the operation interface.

2. The information processing apparatus of claim 1, wherein the controller is configured to execute the predetermined process when judging that the acquired information satisfies a condition related to acquisition information.

3. The information processing apparatus of claim 1,
wherein the operation interface is configured by a keyboard; and
wherein the predetermined operation is an operation on a predetermined key of the keyboard.

4. The information processing apparatus of claim 1,
wherein the operation interface is configured by a touch panel; and
wherein the predetermined operation is an operation on a predetermined area of the touch panel.

5. The information processing apparatus of claim 1, wherein the predetermined process is electronic payment.

6. The information processing apparatus of claim 1, wherein the predetermined process is an authentication process.

7. The information processing apparatus of claim 1, wherein the predetermined process is a process to display information having content corresponding to the acquired information on a display.

8. The information processing apparatus of claim 1, wherein the controller is configured to store the acquired information in a storage in association with an operation executed on the operation interface.

9. An information processing apparatus comprising:
a biological information acquisition interface capable of acquiring biological information of the user and capable of electric field communication with an electric field communication terminal; and
a controller configured to execute a predetermined process when judging that biological information acquired by the biological information acquisition interface satisfies a condition related to a living body and judging that information acquired by electric field communication satisfies a condition related to acquisition information.

10. The information processing apparatus of claim 9, wherein the biological information acquisition interface is configured by a fingerprint sensor capable of acquiring information related to a fingerprint of the user.

11. The information processing apparatus of claim 9, wherein the controller is configured to acquire information used to judge whether the condition related to the living body is satisfied from the electric field communication terminal by electric field communication.

12. An information processing system comprising:
an electric field communication terminal configured to transmit information by electric field communication while being worn by a user; and
an information processing apparatus configured to acquire the information from the electric field communication terminal by electric field communication and configured to execute a predetermined process, using the acquired information, when detecting execution of a predetermined process on an operation interface.

13. An information processing system comprising:
an electric field communication terminal configured to transmit information by electric field communication while being worn by a user; and
an information processing apparatus configured to acquire the information from the electric field communication terminal by electric field communication using a biological information acquisition interface capable of acquiring biological information of the user and configured to execute a predetermined process when judging that biological information acquired by the biological information acquisition interface satisfies a condition related to a living body and judging that the acquired information satisfies a condition related to acquisition information.

14. An information processing method for execution by an information processing apparatus, the information processing method comprising:
detecting an operation executed on an operation interface;
acquiring information from an electric field communication terminal by electric field communication; and
executing a predetermined process, using the acquired information, when execution of a predetermined operation on the operation interface is detected.

15. An information processing method for execution by an information processing apparatus, the information processing method comprising:
acquiring, using a biological information acquisition interface, biological information of a user;
acquiring, using the biological information acquisition interface, information from an electric field communication terminal by electric field communication; and
executing a predetermined process when it is judged that the acquired biological information satisfies a condition related to a living body and that the acquired information satisfies a condition related to acquisition information.
